(19) United States
(12) Patent Application Publication
(10) Pub. No.: US 2014/0120563 A1
(43) Pub. Date: May 1, 2014

(54) ALLERGEN TESTING PLATFORM FOR USE WITH MOBILE ELECTRONIC DEVICES

(71) Applicant: THE REGENTS OF THE UNIVERSITY OF CALIFORNIA, Oakland, CA (US)

(72) Inventors: Aydogan Ozcan, Los Angeles, CA (US); Ahmet F. Coskun, Culver City, CA (US); Justin Wong, San Jose, CA (US)

(73) Assignee: THE REGENTS OF THE UNIVERSITY OF CALIFORNIA, Oakland, CA (US)

(21) Appl. No.: 14/053,475

(22) Filed: Oct. 14, 2013

Related U.S. Application Data
(60) Provisional application No. 61/719,891, filed on Oct. 29, 2012.

(51) Int. Cl. G01N 21/78

(52) U.S. Cl. CPC G01N 21/78
USPC 435/7.94; 435/287.2

(57) ABSTRACT

An allergy testing system for use with a mobile electronic device having a camera includes a housing that can be attached to the mobile electronic device. First and second light sources within the housing are configured to illuminate, respectively, a test sample and a control sample. A colorimetric assay is performed on the test sample and the control sample. The first light source and the second light source are activated and the camera of the mobile electronic device captures images of transmitted light. The relative intensity of transmitted light is then used by software loaded on the mobile electronic device to determine a relative absorbance value. The relative absorbance value is used, together with a calibration curve, to measure the concentration of a particular allergen within the test sample. Based on the concentration of the allergen the test sample can be labeled as either “positive” or “negative.”

### RELATED APPLICATION

This Application claims priority to U.S. Provisional Patent Application No. 61/719,891 filed on Oct. 29, 2013. Priority is claimed pursuant to 35 U.S.C. §119. The above-noted Patent Application is incorporated by reference as if set forth fully herein.

### FIELD OF THE INVENTION

The field of the invention generally relates to colorimetric analysis devices and methods. More particularly, the field of the invention relates to an allergen testing platform that is used in conjunction with a mobile electronic device such as a mobile phone that relies on colorimetric analysis. The method and device uses the mobile electronic device's integrated camera as a detector for colorimetric analysis of samples.

### BACKGROUND

Food allergy is an emerging public concern, affecting as many as 8% of young children and 2% of adults especially in developed countries. Allergic reactions might be life-threating by inducing e.g., respiratory and gastrointestinal symptoms, systemic, cutaneous and fatal reactions, which can even be triggered by small traces of food allergens. Although the Food Allergen Labeling and Consumer Protection Act (FALCPA) ensures the safety of allergic individuals by labeling pre-packaged food with a list of potential allergen-related ingredients, there might be still hidden amounts of allergens in processed food due to possible cross-contamination occurring in the processing, manufacturing and transportation of food samples. FALCPA, for example, does not require advisory warnings or statements about possible cross-contamination of the food item. Toward the detection of such hidden allergens in food products, numerous analytical methods have been developed, including the tests that are based on polymerase chain reaction (PCR), mass spectroscopy, antibody based immunoassays, surface-plasmon-resonance (SPR) biosensors, array immunoassays, and electrochemical immunosensors. These existing approaches have achieved very high sensitivities; however, they are relatively complex and require bulky equipment to perform the test, making them not suitable for personal use in public settings.

### SUMMARY

In one embodiment, a personalized allergen testing platform is provided that runs in conjunction with a portable or mobile electronic device such as a smart phone, tablet PC or iPad having camera functionality, which utilizes a sensitive colorimetric assay processed in same holders (e.g., test tubes) for specific detection and quantification of allergens in food products. This platform is light weight, weighing less than 500 grams and in other embodiments weighing less than 50 grams (e.g., weight less than approximately 40 grams). The device images the sample holder (e.g., sample test tube) along with a sample holder containing a control (e.g., control test tube) using a cost-effective opto-mechanical attachment to the mobile electronic device camera unit. In one embodiment, the attachment includes a relatively inexpensive plastic plano-convex lens, two light-emitting diodes (LEDs), two light diffusers, and circular apertures to spatially control the imaging field-of-view. The sample test tube and the control test tube, once activated with an allergen-specific sample preparation and closed with a cover or a lid, are then inserted into the attachment from the side where the transmission intensities for each tube are acquired using the camera of the mobile electronic device. These images of the sample test tube and the control test tube are then digitally processed within about one second through a software application running on the mobile electronic device for quantification of the amount of allergen present in the sample.

Compared to visual inspection of the sample/control tubes by the human eye, a separate optical readout with its own software and optimized illumination and imaging configuration is significantly more sensitive, repeatable, and immune from manual reading errors. Furthermore, it also permits digital quantification of allergen concentration beyond a yes/no decision. For example, the device may be calibrated with known quantities of an allergen to generate a calibration curve or function. This calibration curve can then be used to derive specific allergen concentrations. When compared to digital processing of mobile phone camera pictures taken without a separate read-out attachment, i.e., under ambient light, the present approach is much more robust since it is independent of the optical spectrum or intensity of external lighting conditions which can significantly vary based on the setting that the test is used, and therefore could result in sensitivity problems in e.g., airplanes or other poorly illuminated environments. Furthermore, using a separate optical attachment on the mobile electronic device eliminates possible image artifacts due to the hand motion of the user, creating a more repeatable, reliable and sensitive platform for personal use in various public health settings. The system may be employed to test for allergens or other substances in a variety of public settings. For example, the platform may be employed at places of employment, restaurants, schools, airplanes, and the like just to name a few.

In one embodiment, an allergy testing system for use with a mobile electronic device having a camera includes a housing configured for detachable attachment to the mobile electronic device at a location adjacent to the camera. A first light source is disposed within the housing and configured to illuminate a control holder containing a control sample therein. A second light source is disposed within the housing and configured to illuminate a sample holder containing a test sample therein. First and second apertures are disposed adjacent to the control holder and sample holder, respectively, wherein the control holder and sample holder is interposed between the first and second apertures and the first and second light sources. A lens is disposed in the housing and interposed between the camera and the first and second apertures. The colorimetric assay is performed with a control sample being loaded into the control holder and the test sample being loaded into the sample holder. The first light source and the second light source are activated and the camera of the mobile electronic device captures images of transmitted light. The relative intensities of light transmitted through the sample holder and the control holder is then used by software loaded on the mobile electronic device to determine a relative absorbance value. The relative absorbance value is used, together with a calibration curve, to measure the concentration of a particular allergen. Based on the concentration of the allergen the test sample can be labeled as either “positive” or “negative.”

In another embodiment, a method of testing an article of food for an allergen using a mobile electronic device having a camera therein includes subjecting a test sample containing the article of food and a control sample containing a known quantity of allergen to a colorimetric assay. The test sample and the control sample are then illuminated with first and second illumination sources. At least a portion of the transmitted illumination is captured through the test sample and the control sample with the camera of the mobile electronic device. The relative intensity of the transmitted illumination through the test sample and the control sample is calculated using software contained on the mobile electronic device. The concentration of the allergen is displayed on the mobile electronic device based at least in part on the calculated relative intensity of the transmitted illumination.

### BRIEF DESCRIPTION OF THE DRAWINGS

FIG. 1A illustrates an allergy testing system according to one embodiment.

FIG. 1B illustrates a base portion of a housing of the allergy testing system.

FIG. 1C illustrates a mobile phone device having attached thereto a testing platform. Also illustrated is an optional base.

FIG. 1D illustrates a schematic representation of the testing platform that is secured to the mobile phone.

FIG. 1E illustrates a lid used to secure the sample holder and control holder according to one embodiment.

FIG. 2 illustrates a general flowchart of the procedures used in the testing platform.

FIGS. 3A and 3B illustrate an exemplary method of calculating the concentration of an allergen using the allergy testing system.

FIG. 4A illustrates a screen shot of a mobile phone having loaded thereon a software application configured to work with the attached testing platform.

FIG. 4B illustrates another screen shot of the mobile phone after the software application of FIG. 4A has been started.

FIG. 4C illustrates another screen shot of the mobile phone listing the instructions for preparing the sample and control.

FIG. 4D illustrates another screen shot of the mobile phone listing the allergen type that is to be tested.

FIG. 4E illustrates the captured images of the sample test tube and the control test tube.

FIG. 4F illustrates a screen shot of the mobile phone illustrating the output from the imaging processing of the image obtained in FIG. 4E. In this illustrative example, an indication is given of whether the sample is “positive” or “negative.” The output also includes the concentration of the allergen in ppm.

FIG. 5 illustrates a peanut allergen calibration curve for the platform obtained using six (6) different sets of calibration samples (0, 1, 2.5, 5, 10, and 25 ppm). Shown enlarged in the inset image is the region near the origin that illustrates the detection limit of the platform.

FIG. 6 illustrates the peanut testing results of three (3) sets of different commercially available cookies using the platform. The cookies tested included peanut butter chocolate (PBC), oatmeal raisin with walnut (ORW), and milk chocolate chip (MCC). Also illustrated in FIG. 6 is the control. Note that the PBC sample was diluted at least 5,000 times with PBS solution so that the relative absorbance value remains within the range of the generated calibration curve. Of course, such a large dilution would not be needed for practical purposes given that such high concentrations would not likely be observed in “hidden” contamination cases.

### DETAILED DESCRIPTION OF THE ILLUSTRATED EMBODIMENTS

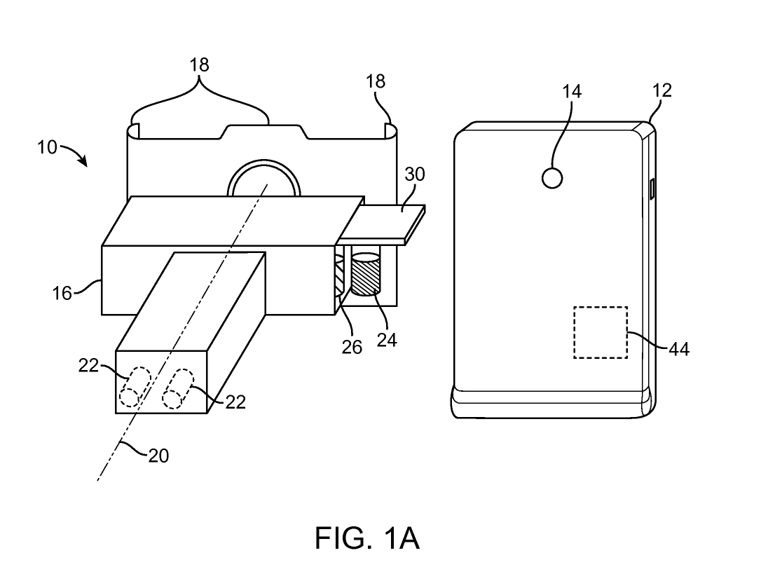

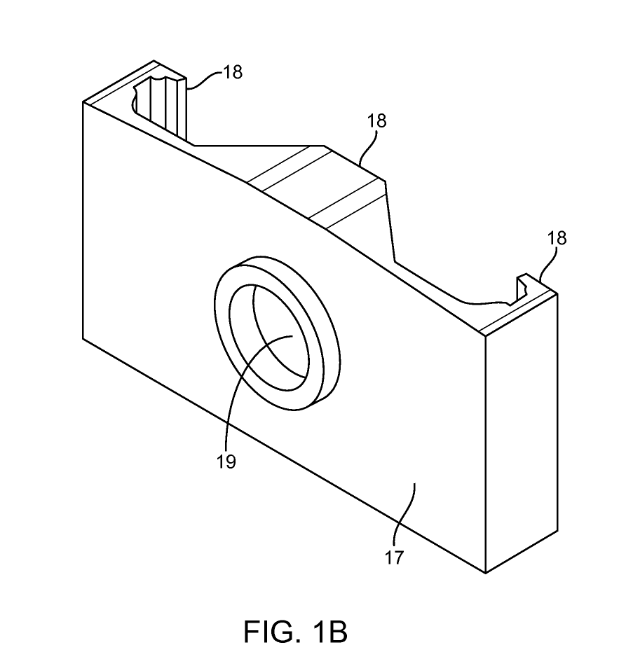

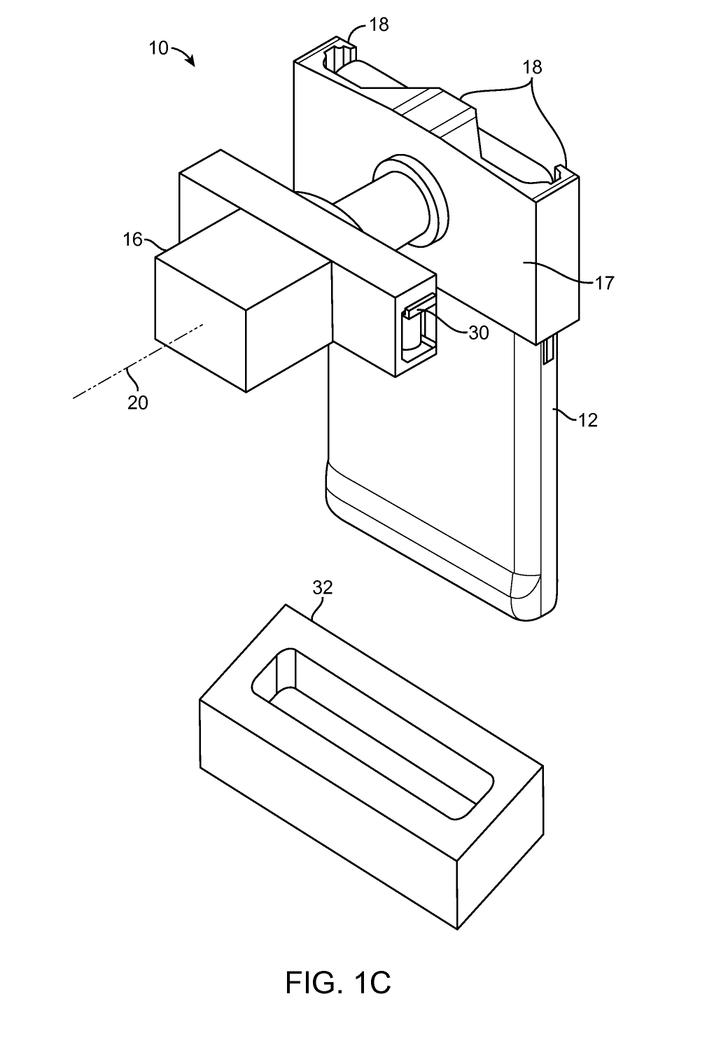

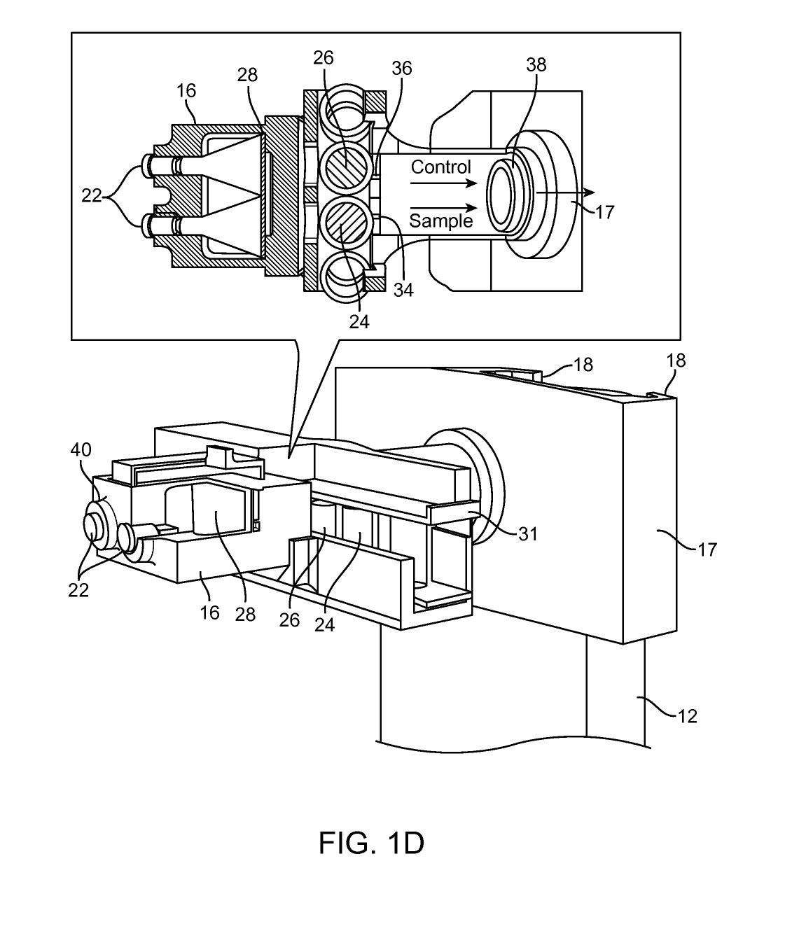

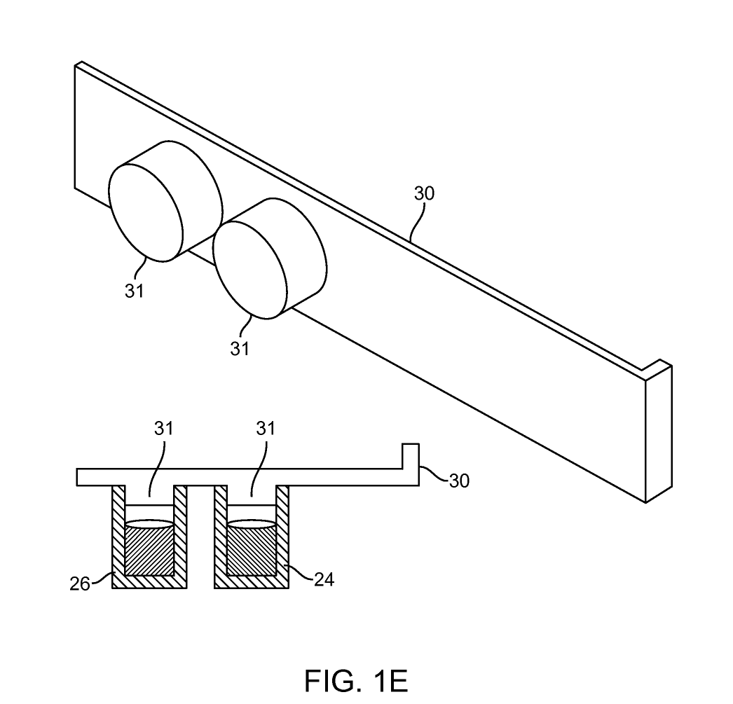

FIGS. 1A-1E illustrates an allergen testing system 10 according to one embodiment. The allergen testing system 10 is used in conjunction with a mobile electronic device 12. The mobile electronic device 12 has a camera 14 contained therein that is used to obtain raw transmission images for the allergen testing system 10. The mobile electronic device 12 contains an image sensor (not shown) as part of the camera 14 that is used to measure the absorption of colorimetric assays. A mobile electronic device 12 is meant to encompass a variety of types of portable or mobile electronic devices such as mobile phones (e.g., Smartphones), tablets, iPads, and the like. As illustrated herein, the mobile electronic device 12 is in the form of a mobile phone and is referred to as mobile phone 12 although it should be understood that other mobile electronic devices can be used as part of the allergen testing system 10. Software 44 loaded onto the mobile phone 12 digitally converts the raw transmission images captured by camera 14 into concentration measurements of allergen that is tested. The software 44 is also able to classify the sample, for example, calling the sample “positive” or “negative.” The mobile phone 12 is typically a SMARTPHONE though many different kinds of mobile phones 12 may be used. The mobile phone 12 may run any number of operating systems. For example, the allergen testing system 10 may run on the ANDROID operating system, the iPhone operating system, or a Windows-based operating system.

The allergen testing system 10 includes a housing 16 that is designed to be removably secured to the mobile phone 12. The housing 16 is thus modular in that it can be secured to the phone and removed therefrom by the user. The housing 16 is typically made from a light weight polymer such as plastic. The housing 16 includes a base portion 17 that is affixed to the housing 16 and acts as an interface to the mobile phone 12 by using one or more fastening tabs 18. FIG. 1B illustrates the base portion 17 which includes an aperture 19 that is dimensioned such that the camera lens of the mobile phone 12 will be positioned within the aperture 19 when the base portion 17 and housing 16 are secured to the mobile phone 12. The fastening tabs 18 are sized to partially wrap around the mobile phone 12 to secure the base portion 17 and housing 16 relative to the mobile phone 12 and place an optical path 20 in line with the camera 14 of the mobile phone 12. Details of the opto-mechanical components disposed along this optical path 20 are described in more detail herein.

In the embodiment of FIGS. 1A-1D, two side fastening tabs 18 and a top fastening tab 18 secure the housing 16 to the mobile phone 12. The relative size of the housing 16 and the fastening tabs 18 may be altered so that the allergen testing system 10 can fit on a number of models and makes of mobile phones 12. The base portion 17 and cylindrical end of housing 16 preferably abuts the face of the mobile phone 12 such that the only light that enters the camera 14 of the mobile phone 12 is the transmitted light from the allergen testing system 10. In this regard, ambient light does not interfere with the sample analysis.

The portion of the housing 16 that contains the opto-mechanical parts aligned in the optical path 18 is generally oriented perpendicular to the face of the mobile phone 12 containing the camera 14. As best seen in FIG. 1D, the housing includes two light sources 22 that are used to illuminate the sample and control as explained in more detail herein. As seen in FIG. 1D, the light sources 22 may include light emitting diodes (LEDs) although other light sources such as laser diodes may be used. Two such LED light sources 22 are illustrated. Light from one LED light source 22 is configured to illuminate the sample test tube (described below) while light from the other LED light source 22 is configured to illuminate the control test tube (also described in more detail below). The wavelength of the LED light sources 22 may be chosen to match the absorption spectrum of the colorimetric assay that is to be performed.

The housing 16 also contains a sample holder 24 that is configured to hold a sample containing the food/beverage item to be tested and a control holder 26 that is configured to hold a sample containing a known concentration of the allergen. The sample holder 24 and the control holder 26 are designed to removable from the housing 16 portion of the allergy testing system 10. In this manner, the sample holder 24 and the control holder 26 can be transferred into the housing 16 when needed to perform the allergen testing. In one embodiment, the sample holder 24 and the control holder 26 may be functionalized with antibodies as part of a sandwich ELISA assay whereby the colorimetric assay is performed within the sample holder 24 and the control holder 26. The sample holder 24 and control holder 26 may even be part of a colorimetric assay kit. While at least one sample holder 24 and at least one control holder 26 are needed for the system, in alternative embodiments, there may be multiple sample holders 24 and multiple control holders 26.

In one aspect, the sample holder 24 and the control holder 26 may include optically transparent tubes (e.g., test tubes). The sample holder 24 and the control holder 26 may be made from an optically transparent material such as plastic or glass although other materials may be used. The sample holder 24 and the control holder 26 define a cross-sectional area that needs to be illuminated by the light sources 22. In this regard, an optional diffuser 28 is interposed between each light source 22 and the sample holder 24 and the control holder 26 to ensure that the sample and control are fully illuminated.

The sample holder 24 and the control holder 26 can be secured to a moveable lid 30 as best seen in FIG. 1E. The moveable lid 30 includes projections 31 that are dimensioned to snugly fit (e.g., projections 31 act like plugs) within the open ends of the sample holder 24 and the control holder 26. In, this manner, the sample holder 24 and the control holder 26 can be secured to the moveable lid 30 when the lid is in the open configuration. The moveable lid 30 is configured to be slideable relative to the housing 16 so the sample holder 24 and control holder 26 can be easily loaded into the device. In the configuration illustrated in FIGS. 1A and 1C, the sample holder 24 and the control holder 26 are being loaded into the housing 16 with the moveable lid 30 slid in the open position. After the sample holder 24 and the control holder 26 have been secured to the moveable lid 30, the moveable lid 30 can be pushed inward into the housing to move the sample holder 24 and the control holder 26 into the optical path 20 as seen in FIG. 1D. The moveable lid 30 and/or housing 16 may include cover that can close the opening where the sample holder 24 and control holder 26 so that light does not enter the interior of the housing 16.

In the configuration of FIGS. 1A-1E, the sample holder 24 and the control holder 26 are oriented in the vertical direction. This orientation ensures that the fluid contained in the sample holder 24 and the control holder 26 does not spill. The allergy testing system 10 may include an optional stand 32 (seen in FIG. 1C) that is used to orient the mobile phone 12 in the vertical orientation when the mobile phone 12 is placed therein. Alternatively, the housing 16 may be oversized and integrate standing functionality therein so that the mobile phone 12 and housing 16 can be oriented properly during the testing procedure. Of course, if appropriate seals (not shown) are placed between the moveable lid 30 and the sample holder 24 and the control holder 26, the vertical orientation may not be necessary.

Referring to FIG. 1D, that transmitted light that passes through the sample holder 24 and the control holder 26 is then passed through respective circular apertures 34, 36 (e.g., 1.5 mm diameter). The light passing through the apertures 34, 36 then enters a lens 38 that is also disposed in the housing 16 and located within the optical path 20. The lens 38 may include a plano-convex lens (e.g., Edmund Optics, NT65-576, Focal length ˜28 mm) This imaging configuration provides an optical demagnification of the sample holder 24 and control holder 26 cross-sections by 28/4=7 fold, which permits fitting both the sample holder 24 and the control holder 26 into the field-of-view of the camera 14 of the mobile phone 12. Note that in FIG. 1D two additional holders are illustrated on either side of the sample holder 24 and control holder 26. While only two such holders are needed for the system (one for sample holder 24 and one for control holder 26), in other embodiments, there may be additional holders that can hold, for example, multiple samples and/or multiple controls.

The light sources 22 are powered by one or more batteries 40 that are located within the housing 16. For example, the battery 40 may include a button battery (2V) integrated into the housing 16. Alternatively, in some embodiments, power may be delivered via the mobile phone 12 itself In this alternative embodiment, for example, the USB or other port on the mobile phone 12 may serve as a conduit of power needed or the light sources 22.

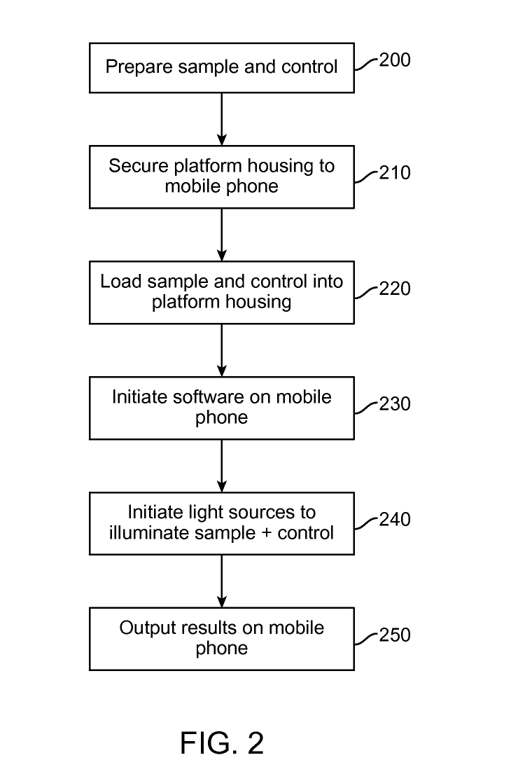

FIG. 2 illustrates a general method of testing a sample for an allergen using the allergy testing system 10 described herein. In operation 200, the sample and control are prepared. A sample is taken of the food item of interest and prepared. This process may involve grinding the sample to a small particle size and contacting the same with one or more solutions or extraction agents. For example, hot or heated water in combination with one or more solvents may be needed to extract the particular allergen component. In the particular experiments described in detail herein, for example, the sample and control are prepared using a commercially available kit (e.g., peanut Veratox test kit, Neogen, 8430). The particular allergen testing kit may use any number of mechanisms to produce a color change in the sample. In the peanut Veratox test kit that is used in the experiments herein, a sandwich ELISA antibody-based system is used to assay for the presence of peanuts. In this test kit, samples and controls are transferred to a sample holder 24 and a control holder 26 that contain antibodies bound to an inner surface and are incubated for about ten (10) minutes. After incubation, the liquid contained in the sample holder 24 and the control holder 26 are dumped and the sample holder 24 and the control holder 26 are washed (preferably several times) with a washing solution. The washing solution is removed and a first reagent (conjugate—blue bottle) is added via a dropper (e.g., around three droplets) to the sample holder 24 and the control holder 26 and incubated for about ten (10) minutes. After incubation, the liquid contained in the sample holder 24 and the control holder 26 are dumped and the sample holder 24 and the control holder 26 are washed with a washing solution. The washing solution is removed and a second reagent (substrate—green bottle) is added to the sample holder 24 and the control holder 26 via the dropper (e.g., around three droplets) and incubated for about ten (10) minutes. After this second incubation period, the liquid contained in the sample holder 24 and the control holder 26 are dumped and the sample holder 24 and the control holder 26 are washed with a washing solution. The washing solution is removed and a third reagent (stopping agent—red bottle) is added to the sample holder 24 and the control holder 26 with the dropper (e.g., around three droplets). The sample holder 24 and the control holder 26 are now ready to be loaded into the housing 16.

In some embodiments, the sample/control kit may be sold in combination with the allergy testing system 10. In other embodiments, the sample/control kit may be sold separately from the allergy testing system 10. In some embodiments, the sample holder 24 and the control holder 26 may be unique to the particular sample/control kit but may are still able to loaded onto the moveable lid 30. In other instances, the sample holder 24 and the control holder 26 may be used across multiple different sample/control kits. In this last configuration, the allergy testing system 10 may work with multiple, different allergy testing kits. The allergy testing system 10 may be used to detect a number of different allergens. These include, by way of illustration and not limitation, nuts such as peanuts, cashews, almonds, hazelnuts, and walnuts. Other allergens include casein, crustacean allergen (for shellfish), eggs, gliadins, glutenins, lupin, mustard, soy, wheat, sesame, and milk.

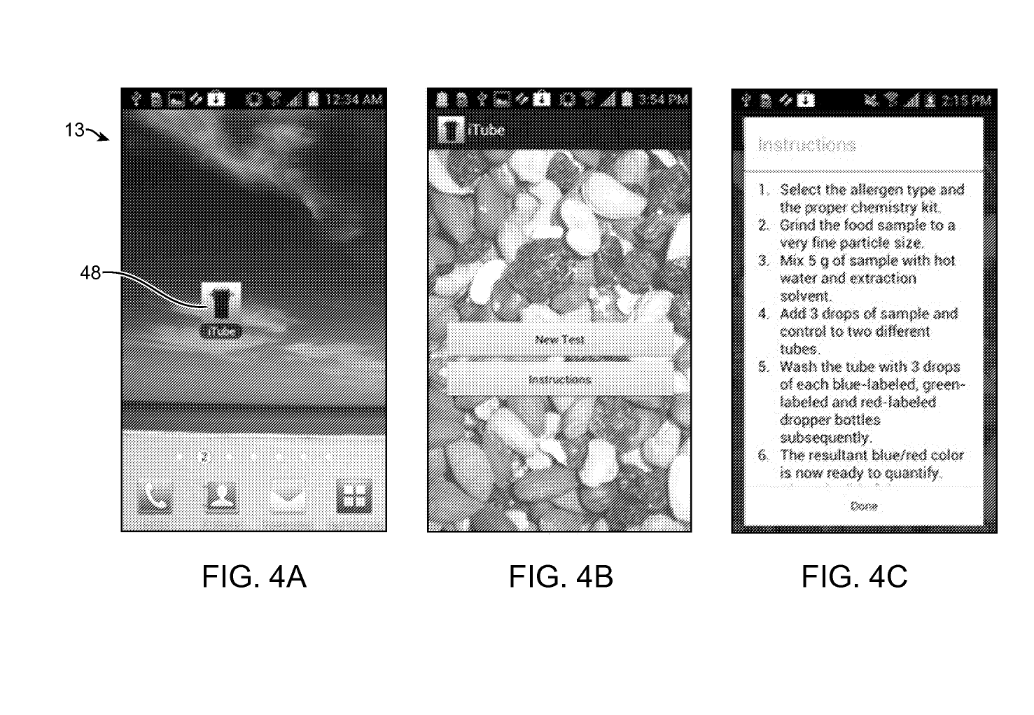

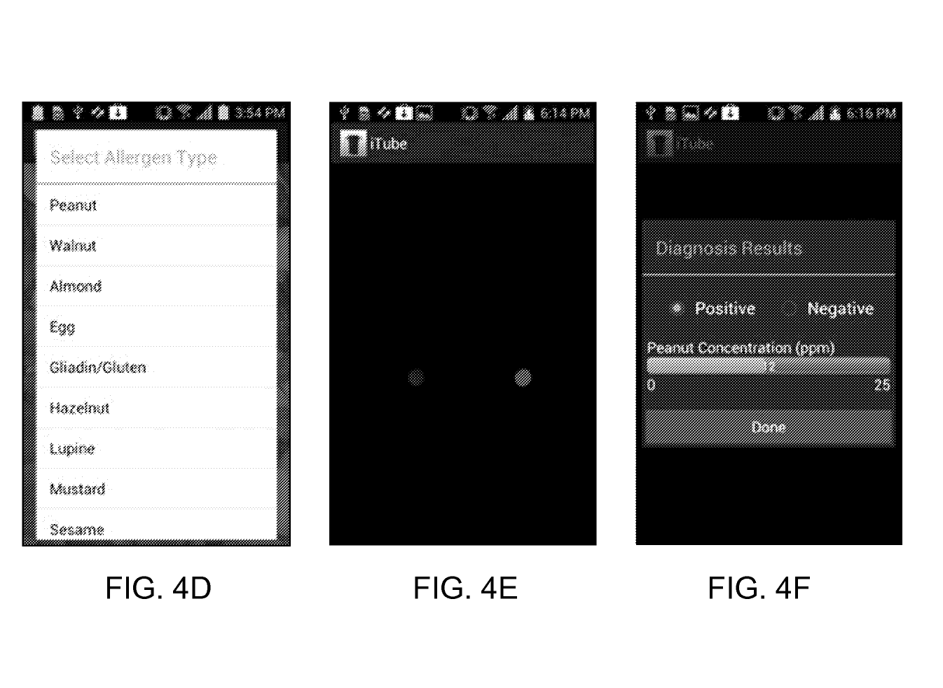

Referring back to FIG. 2, in operation 210, the base portion 17 and housing 16 of the allergy testing system 10 is secured to the mobile phone 12. It should be noted that securing the housing 16 to the mobile phone 12 may be performed before or after sample and control preparation operation 200. After the sample and control have been prepared, as seen in operation 220, the sample and control are loaded into the housing 16 using the sample holder 24 and the control holder 26 described herein. The sample holder 24 and control holder 26 can be secured to the lid 30 via the projections 31 and the lid 30 can be closed to place the sample holder 24 and the control holder 26 within the optical path 20. With the sample holder 24 and the control holder 26 loaded into the allergy testing system 10, the user can initiate the analysis software 44 (FIG. 1A) contained in the mobile phone 12 as seen in operation 230. This is accomplished, for example, by the user selecting the application or “app” on the screen 13 of the mobile phone 12 (FIG. 4A). Initiating the analysis software 44 prepares the camera 14 of the mobile phone 12 to receive illumination passing through the sample holder 24 and the control holder 26. Still referring to FIG. 2, as seen in operation 240, the light sources 22 are initiated to illuminate the sample holder 24 and the control holder 26. It should be understood that in some embodiments, the light sources 22 are initiated manually (via a switch or button not shown) but in other embodiments such as where the mobile phone 12 powers the light sources 22, the light sources 22 are initiated automatically. Further, while FIG. 2 shows that initiation of the light sources 22 occurs after initiation of the software 44 it should be understood that the order of the operation may be reversed.

In operation 250, the analysis software 44 processes the raw intensity data received by the camera 14 of the mobile phone 12 and outputs results to the user which can be displayed on the display of the mobile phone 12. For example, the output that is displayed on the mobile phone 12 may include an indicator whether the sample was “positive” or “negative” for the particularly tested allergen. Alternatively, or in addition to, the output may also include the concentration of the allergen. For example, the concentration of the detected allergen may be listed numerically as parts per million (ppm). In one embodiment, the output of the result is limited to being displayed to the user on the mobile 12. In another embodiment, the output of the result may be transmitted to a remotely located database or server computer which can then be stored for later viewing or may be combined with data from other users which can then be part of a crowd-sourced database. For example, the data that is transmitted remotely may be associated with a particular food item which includes the manufacturer. Multiple “positive” results for a particular allergen associated with a manufacturer's food article may indicate that cross-contamination is occurring somewhere in the food manufacturing process. In this regard, the remote database may serve as an early warning system that can alert users and appropriate government agencies of possible food allergy risks.

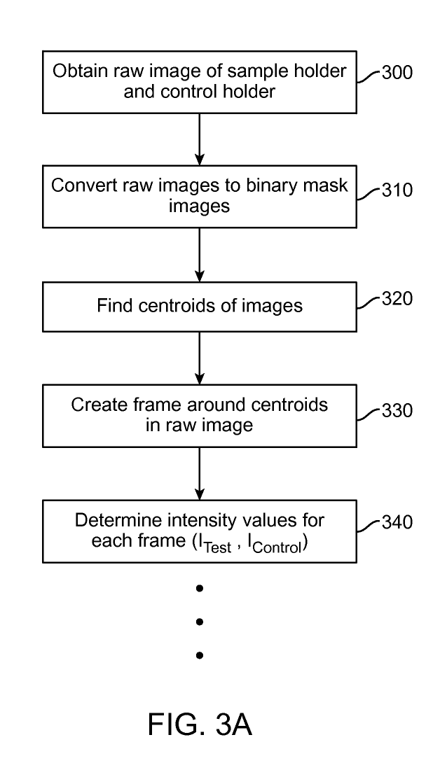

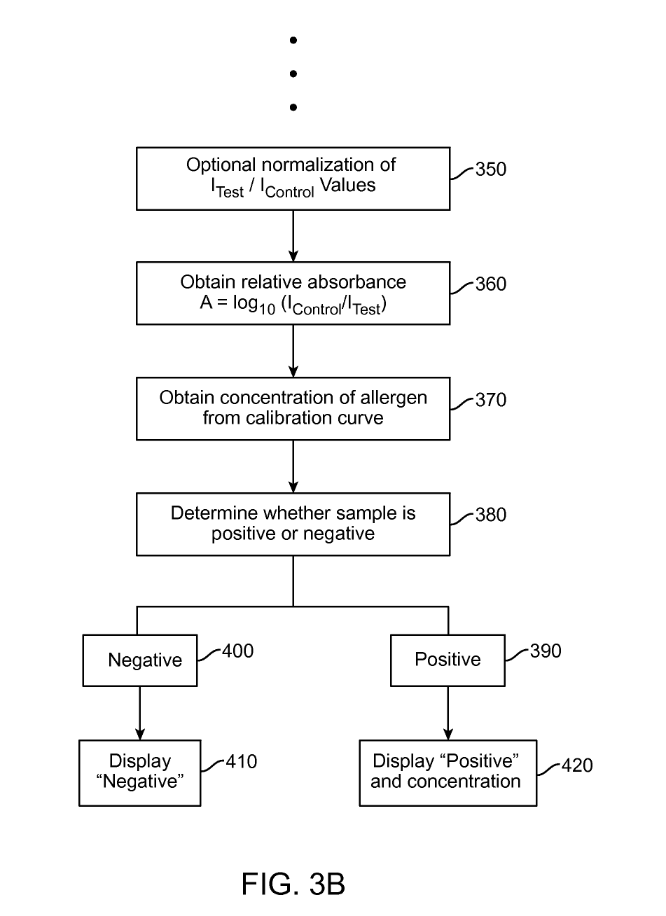

FIGS. 3A and 3B illustrates details of the steps employed by the analysis software 44 to analyze the images of the sample holder 24 and the control holder 26 obtained by the camera 14 of the mobile phone 12. In operation 300, the raw image of the transmitted light impinging on the image sensor of the camera 14 is obtained for both the sample holder 24 and the control holder 26. In operation 310, the raw images are converted to binary mask images. In operation 320, a call function is executed to find the centroids of the images from the sample holder 24 and the control holder 26. As an example, the analysis software 44 may use MATLAB regionprops function to find the centroid. Next, in operation 330, a frame is drawn around each identified centroid in the raw image. For example, the frame may be around 300 pixels×300 pixels. Next, in operation 340, each frame is integrated to determine an intensity value associated with the sample holder 24 (Iₜₑₛₜ) and the control holder 26 (I_{control}). I_{control} is the transmitted signal for the control holder 26 and Iₜₑₛₜ is the transmitted signal for the tests holder 24.

Once the intensity values associated with the sample holder 24 (Iₜₑₛₜ) and the control holder 26 (I_{control}) have been determined, it may be necessary to apply a normalization factor to either the Iₜₑₛₜ and I_{control} values because of small variations in the LED intensity of the light sources 22. For example, despite being driven by the same control circuitry, one LED might illuminate more brightly than the other LED. To compensate for this, brighter LED may be divided by a normalization factor to take this into account. FIG. 3B illustrates a continuation of the process of FIG. 3A whereby in operation 350 there is an optional normalization of Iₜₑₛₜ and I_{control} values. Next, in operation 360 the relative absorbance A is determined based on the following equation:

A=log (I_{control}/Iₜₑₛₜ) Eq. 1

Once the relative absorbance is obtained in operation 360, the concentration of the allergen is obtained from a calibration curve created that associates the relative absorbance A with allergen concentration as seen in operation 370. Typically, in the low concentration range that the allergy testing system 10 is used, this relationship is a linear. For example, as explained below with regard to experimental results obtained using the allergy testing system 10 the linear fit was A=0.028*C where C is the allergen concentration in ppm. After the concentration of the allergen is determined, a determination is made whether the sample in the sample holder 24 was “positive” or “negative” as seen in operation 380. In this operation, the concentration is compared with a threshold value that determines whether or not the sample is positive or negative. The threshold value may be determined by the detection limit of the allergy testing system 10. For example, if the detection limit is 1 ppm then a concentration above 1 ppm would be classified as positive. This is illustrated in operation 390 of FIG. 3B. Conversely, a concentration limit that is less than 1 ppm would be classified as negative. This is illustrated in operation 400 of FIG. 3B. In the event of a negative result, the display of the mobile phone 12 would contain a “negative” display as seen in operation 410. In the event of a positive result, the display of the mobile phone 12 would contain a “positive” display as seen in operation 420. In addition to the positive display, the concentration of the allergen is also displayed to the user on the display of the mobile phone 12.

FIG. 4A illustrates a display or screen 13 of a mobile phone 12 showing an icon 48 for the analysis software 44. The icon 48 is labeled iTube and is initiated by touching the icon 48 as is typically done with other mobile phone applications. FIG. 4B illustrates a screen shot of the display of the mobile phone 12 that presents the user with two options that are selected by touch screen commands. A first icon labeled “New Test” initiates a new test while a second icon labeled as “Instructions” presents the user with specific instructions for the testing protocol. FIG. 4C illustrates exemplary instructions for preparing a sample according to one embodiment. FIG. 4D illustrates a menu available to the user where he or she selects the allergen of interest that is to be tested. The user selects the appropriate test by touching the screen 13 of the mobile phone 12. FIG. 4E illustrates the display of the mobile phone 12 after the sample holder 24 and control holder 26 (with sample and control, respectively contained therein) have been loaded into the housing 16, the illumination sources 22 have been triggered and camera 14 has been turned on. One can see the two dots where transmitted light reaches the image sensor of the camera 14. To capture an image for image processing and analysis a user can touch the screen or display 13 to capture the transmission images of the sample holder 24 and the control holder 26. FIG. 4F illustrates the output of the analysis software 44 that is displayed to the user. In this situation, the sample is labeled as “positive” and shows a peanut concentration of 12 ppm using a graphical bar that spans between 0 ppm and 25 ppm. The analysis software 44 is able to quickly output a result to user, typically within a few seconds.

### EXPERIMENTAL

### Methods

Hardware design: In this experiment, the allergy testing system was implemented on an Android phone (Samsung Galaxy S II, 1.2 GHz Dual Core ARM Cortex-A9 Processor, 8MP Camera with F/2.65 aperture and 4 mm focal length lens). The same allergy testing system can also be built on other smart-phones, including iPhone as well as other Android devices with slight mechanical modifications. The three dimensional structure of the housing was designed using Inventor software (Autodesk) and built using a 3D printer (Elite, Dimension), providing a lightweight (˜40 grams) and robust hardware that can be operated in field conditions. In this design, two interchangeable LEDs (Digikey, 751-1089-ND, 650 nm peak wavelength with 15 nm bandwidth) were used to vertically illuminate the sample holder (sample test tube) and the control holder (control test tube). The wavelength of the LEDs was specifically chosen to match the absorption spectrum of the colorimetric assay performed in the sample test tube and the control test tube. To uniformly illuminate the cross-section of each test tube (i.e., 8 mm×12 mm), two diffusers (Digikey, 67-1845-ND) were also interposed in the optical path between the LEDs and the sample/control tubes. The transmitted light through each tube of interest is then collected via two circular apertures (1.5 mm diameter) to be imaged onto the digital camera of the mobile phone using a plano-convex lens (Edmund Optics, NT65-576, Focal length ˜28 mm) This imaging configuration provides an optical demagnification of the tube cross-section by 28/4=7 fold, which permits fitting both the test tube (i.e., sample) and control tubes into the field-of-view of the mobile phone camera.

Android based smart application: In this experiment, the analysis software was developed in an Android application which functions described herein and illustrated in FIGS. 4A-4F. To start the program, the user clicks on the iTube icon and starts to run the smart application on the mobile phone. The next window provides two options to the user—either “New Test” or “Instructions.” Once the “Instructions” button or tab is selected, the user protocol for the allergen testing is displayed as seen in FIG. 4C. Otherwise, if “New Test” is selected, the user is asked to identify the allergen type to be tested as seen in FIG. 4D. When the user decides on the type of the allergen to be tested (e.g., peanut), the mobile phone application powers on the digital camera of the phone. The user can then touch the screen 13 of the mobile phone to simultaneously capture the transmission images of the tubes (i.e., both the sample test tube and control test tube). These captured images are then processed within one second to determine the concentration of the selected allergen within a range of 1 to 25 parts per million (ppm). The test result is displayed as “positive” for >1 ppm or “negative” for <1 ppm. Of course, this threshold may change depending on the detection limit of the device.

Digital processing of tube images: The acquired transmission images of test tubes (sample and control) are first converted into binary mask images by localizing their centroids. A frame (i.e., 300×300 pixels) around each one of these centroids is then used to calculate a transmission signal per tube. The resulting signal of the control tube is divided by a normalization factor (when applicable), and then is divided by the signal calculated for the sample tube to determine the relative absorbance (A) of the assay per Equation 1 herein, which scales with the allergen concentration within the sample. Finally, this relative absorbance value is divided by a calibration factor that yields the final concentration of the allergen (in ppm) measured within the sample of interest.

Colorimetric assay preparation: In this experiment, to demonstrate the functionality of the allergy testing system, colorimetric assays were performed based on a food allergy test kit that is specific to peanuts, i.e., Veratox test kit, Neogen, 8430 (Neogen Corporation, Lansing Michigan). The assay preparation starts with grinding the target food sample to a fine particle size and then ˜5 grams of the ground food sample is mixed with hot water (50-60° C.) and extraction solvent (10 mM PBS to 1L distilled or deionized water). Three drops of this sample solution and the control solution that does not contain any food, are added separately to two different tubes (sample test tube and control test tube). Following ˜10 minutes of incubation, the test and control tubes are rinsed sequentially with wash buffer solution (10 mM PBS-Tween added to 1 L distilled or deionized water) followed each time with 3 drops of blue-labeled (conjugate), green-labeled (substrate) and red-labeled (stop solution) dropper bottles. The additional washes and incubation add another ˜10 minutes to sample preparation in total. The resultant blue and red mixture color activated in the test tubes can then be measured by the allergy testing system implemented on the mobile phone, providing a quantified measurement of the peanut concentration within the sample.

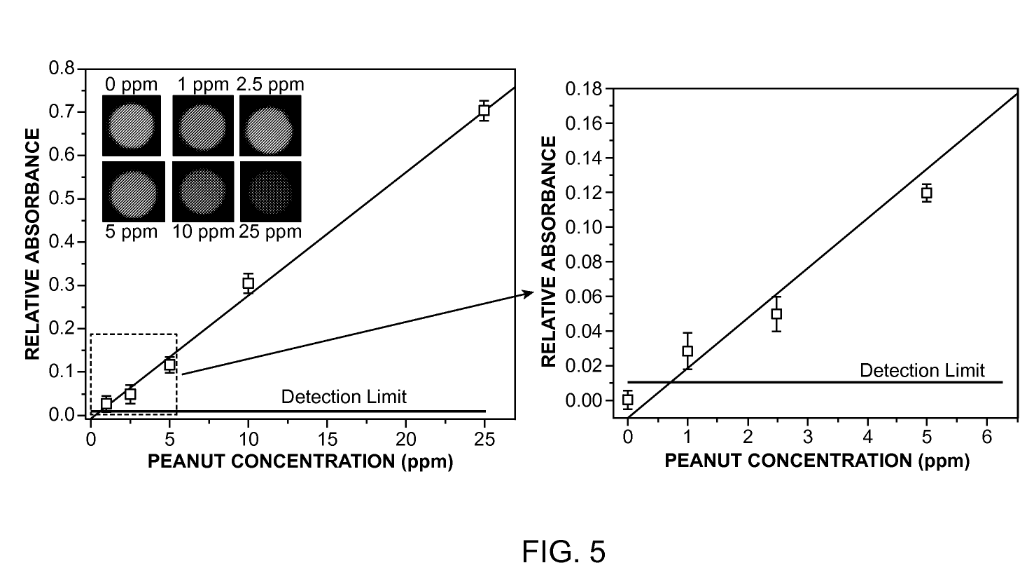

System calibration: The allergy testing system was calibrated by testing known amounts of peanut concentrations, ranging from 0 ppm, 1 ppm, 2.5 ppm, 5 ppm, 10 ppm and 25 ppm. FIG. 5 illustrates the calibration curve created using these samples. The calibration samples were then digitally quantified using the device to find the relative absorbance (A) of each test tube using Equation 1 above. Assuming that the optical properties (e.g., reflection, absorption) of the test tube containers are the same for both the sample and control tubes and that the illumination is uniform, i.e., approximately the same for both tubes, then A would be correlated to the concentration of the allergen in the sample tube. In the tested device, however, the LED intensity illuminating the control tube was measured to be slightly higher (i.e., 1.15 fold higher), and therefore the transmitted control signal (I_{control}) was divided by a normalization factor of 1.15 to take this into account. Following four (4) different tests for each concentration of peanuts (spanning 0 ppm to 25 ppm), the calibration curve of FIG. 5 provides a linear fit with R=0.99, i.e., A=0.028 * C, where C is the peanut concentration in ppm. This linear fit/equation is used to quantify the target allergen concentration (C) in a given food product of interest by measuring the relative absorbance of the target sample (A). Based on the calibration experiments, the peanut detection limit is also found as ˜1 ppm as illustrated in FIG. 5 (see inset).

Results and Discussion

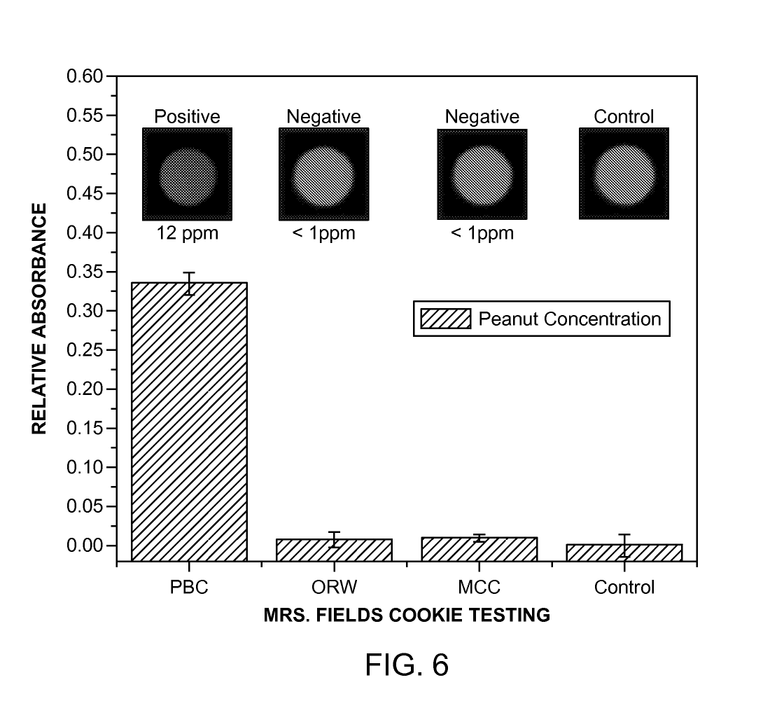

The performance of the platform was evaluated by testing three (3) different kinds of commercial brand cookies (MRS. FIELDS cookies), such that peanut butter chocolate (PBC), oatmeal raisin with walnut (ORW) and milk chocolate chip (MCC) cookies were tested (each repeated 3 times) for quantification of their peanut concentrations. FIG. 6 illustrates the test results, processed through the iTube application running on the mobile phone. The tests revealed that, as expected, PBC was found positive for peanut testing and had a relative absorbance value of 0.33, corresponding to a peanut concentration of 12 ppm. It should be emphasize that in these measurements the PBC extract was diluted at least 5,000 times with phosphate buffered saline (PBS) solution so that the relative absorbance value remained within the range of our calibration curve. Therefore, the actual peanut concentration within the PBC sample was in fact >60,000 ppm. Of course, this large dilution factor is not necessary for practical purposes since such high concentrations of allergens are not typically found in contamination cases. If desired, however, a set of successive measurements with varying dilution levels could be used to accurately quantify allergen concentrations that are e.g., larger than 1,000 ppm.

ORW was negative for peanut testing and had negligible relative absorbance, corresponding to a peanut concentration of <1 ppm, i.e., at the level of the control test tube signal. In this case, we did not get any positive signal due to walnuts present in the cookie, verifying the specificity of our test results to peanuts. MCC was also found negative for peanut testing and had negligible absorbance, corresponding to a peanut concentration of <1 ppm.

Although the experiments were performed for peanut allergen testing, the allergy testing system can be employed for a variety of other allergens, including e.g., casein, almond, egg, gluten, gliadin, hazelnut, lupine, mustard, sesame, crustacean, soy as well as milk. The allergic individuals can choose the allergen type from the mobile phone application menu, which should be pre-programmed with different calibration factors for each allergen type of interest and its associated test kit. Finally, as the allergic individuals use the platform to perform allergen testing, the test results of various food products can be uploaded to remote servers or databases to create a personalized testing archive, which could provide additional resources for allergic individuals globally. Such a statistical allergy database and its spatio-temporal analysis could especially be useful for food related regulations and policies instructed in for example restaurants, food production lines as well as consumer protection organizations.

A main advantage of the allergy testing system disclosed herein over other allergy testing solutions such as the VERATOX testing kits sold by Neogen Corporation is that one does not need a separate and expensive reader device to test the samples as the allergy testing system disclosed herein uses a small, inexpensive reader device that can be used with a wide variety of portable electronic devices (with camera functionality) that people already have in their possession. The reader devices sold by Neogen Corporation are rather large and bulky and are not suited to be portable. For example, unlike the present allergy testing solutions, the Neogen readers would not be something a child would take to school or carry in a purse or handbag.

Also, there is the ability to communicate the results to a remote location in an easy manner. Similarly, software may be updated with additional features and functionality by straightforward updates of the application contained on the portable electronic device. The connectivity aspect allows the transfer and remote storage of information to databases. These databases may be monitored or otherwise analyzed such that rapid determinations can be made about instances of food cross-contamination. For example, data may be transferred that includes the identification of the manufacturer, the product name, and lot number. If a significant number or spike in positive test results are found that are common amongst a particular product or product lot, appropriate government agencies and/or manufacturers/distributers (e.g., USDA, retail outlets) may be alerted to the potential of cross-contaminated products.

While embodiments have been shown and described, various modifications may be made without departing from the scope of the inventive concepts disclosed herein. The invention(s), therefore, should not be limited, except to the following claims, and their equivalents.

What is claimed is:

1. An allergy testing system for use with a mobile electronic device having a camera comprising:
a housing configured for detachable attachment to the mobile electronic device at a location adjacent to the camera;
a first light source disposed within the housing and configured to illuminate a control holder containing a control sample therein;
a second light source disposed within the housing and configured to illuminate a sample holder containing a test sample therein;
first and second apertures disposed adjacent to the control holder and sample holder, respectively, wherein the control holder and sample holder is interposed between the first and second apertures and the first and second light sources; and
a lens disposed in the housing and interposed between the camera and the first and second apertures.

2. The allergy testing system of claim 1, further comprising a diffuser interposed between the first light source and the control holder and a diffuser interposed between the second light source and the control holder.

3. The allergy testing system of claim 1, further comprising a power source disposed in the housing and configured to power the first light source and the second light source.

4. The allergy testing system of claim 1, wherein the first light source and the second light source are coupled to a power source contained in the mobile electronic device.

5. The allergy testing system of claim 1, wherein the control holder and the sample holder comprise bound antibodies as part of a sandwich ELISA assay.

6. The allergy testing system of claim 5, wherein the sandwich ELISA assay is specific for an allergen selected from the group comprising nuts, casein, crustacean allergen, eggs, gliadins, gluten, lupin, mustard, soy, wheat, sesame, and milk.

7. The allergy testing system of claim 1, wherein the mobile electronic device comprises software loaded thereon that is configured to calculate the relative intensity of light of the control sample and test sample received at the camera.

8. The allergy testing system of claim 7, wherein the software is configured to output the measured concentration of an allergen in the test sample.

9. The allergy testing system of claim 8, wherein the software is configured to output a “positive” or “negative” reading of the test sample based at least in part on a comparison of the measured concentration with a threshold value.

10. The allergy testing system of claim 5, further comprising an allergen testing kit comprising:
an allergen extractor;
one or more control samples having a known concentration of allergen; and
a plurality of sandwich ELISA reagents.

11. The allergy testing system of claim 10, wherein the light sources comprise LEDs or laser diodes.

12. The allergy testing system of claim 1, further comprising a stand configured to hold the mobile electronic device in a substantially vertical orientation.

13. The allergy testing system of claim 1, wherein the control holder comprises multiple control samples and wherein the sample holder comprises multiple test samples.

14. A method of testing an article of food for an allergen comprising:
exposing the article of food to an extraction solution;
transferring a portion of the extraction solution exposed to the article of food to a sample holder comprising a sandwich ELISA assay;
transferring a control sample having a known concentration of allergen to a control holder comprising a sandwich ELISA assay;
emptying the sample holder and control holder;
washing the sample holder and control holder with a wash buffer;
exposing the sample holder and control holder to a first sandwich ELISA reagent;
washing the sample holder and control holder with a wash buffer;
exposing the sample holder and control holder to a second sandwich ELISA reagent;
washing the sample holder and control holder with a wash buffer;
exposing the sample holder and control holder to a third sandwich ELISA reagent; and
inserting the sample holder and control holder into the housing of the system of claim 1; and
powering the first and second light sources;
measuring the relative intensities of light passing through the sample holder and control holder; and
calculating a concentration of the allergen based at least in part on the measured relative intensities of light passing through the sample holder and the control holder.

15. A method of testing an article of food for an allergen using a mobile electronic device having a camera therein comprising:
subjecting a test sample containing the article of food and a control sample containing a known quantity of allergen to a colorimetric assay;
illuminating the test sample and the control sample with first and second illumination sources;
capturing at least a portion of the transmitted illumination light through the test sample and the control sample with the camera of the mobile electronic device;
calculating the relative intensity of the transmitted illumination light through the test sample and the control sample using software contained on the mobile electronic device; and
displaying a concentration of the allergen on the mobile electronic device based at least in part on the calculated relative intensity of the transmitted illumination light.

16. The method of claim 15, further comprising displaying on the mobile electronic device an indication of a positive sample or a negative sample based on the concentration of the allergen.

17. The method of claim 15, further comprising transmitting the concentration of the allergen to a remote computer or database.

18. The method of claim 15, wherein the allergen is selected from the group comprising nuts, casein, crustacean allergen, eggs, gliadins, gluten, lupin, mustard, soy, wheat, sesame, and milk.

19. The method of claim 15, wherein the colorimetric assay comprises a sandwich ELISA assay.

20. The method of claim 15, wherein the first and second illumination sources are contained in a housing configured to be detachably mounted to the mobile electronic device.
